(19) United States
(12) Patent Application Publication
(10) Pub. No.: US 2009/0291425 A1
(43) Pub. Date: Nov. 26, 2009

(54) EDUCATIONAL TOOL

(76) Inventor: Ian GROVE-STEPHENSEN, Cambridge (GB)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 12/466,682

(22) Filed: May 15, 2009

Related U.S. Application Data
(60) Provisional application No. 61/131,231, filed on Jun. 6, 2008.

(30) Foreign Application Priority Data
May 20, 2008 (GB) 0809159.7

(51) Int. Cl. G09B 7/00

(52) U.S. Cl. 434/350

(57) ABSTRACT

An educational network for grading the performance of a student in a test sat by a plurality of students, comprising a database storing a test to be assessed for said plurality of students; a plurality of student work stations connected to said database to enable said plurality of students to input answers to said task, wherein said answers are stored on said database; and a controller. Said controller being configured to distribute each answer by each said student to at least two other students from the plurality of students; collect scoring data for each answer from the at least two other students; determine outlying results in said scoring data; calculate a performance mark for each said student based on said collected data without said outlying results; calculate a conformance value for each said student based on the difference between the scoring data awarded by each said student to other students from the plurality of students and calculated performance marks for each of said other students marked by each said student, and calculate an overall grade for each said student from said calculated performance mark and said consistency.

The present application claims priority under 35 USC §119 to British Patent Application No. 0809159.7 filed on May 20, 2008 and U.S. Provisional Application No. 61/131,231 filed Jun. 6, 2008, the entire disclosures of both are incorporated herein by reference.

### FIELD OF THE INVENTION

This invention relates to an educational tool for marking answer scripts from students sitting examinations, in particular, online examinations.

### BACKGROUND TO THE INVENTION

In education it is common practice for a teacher to set a test for students and to have the students sitting the test mark other students' work. This is an efficient way of marking the students' scripts and also has pedagogical benefits. However, there are three particular problems:
1) The accuracy of the marks awarded to each student depends on the ability of the student doing the marking;
2) Collusion between pairs/groups of students to inflate each others' marks is common, and
3) Learning is limited to what a pair/group of students can teach each other.

### SUMMARY OF THE INVENTION

According to the invention there is provided a method of determining the performance of a student in a test sat by a plurality of students comprising distributing each answer by each said student to at least two other students from the plurality of students; collecting scoring data for each answer from the at least two other students; calculating a performance value for each said student based on said collected data; calculating a conformance value for each said student based on the difference between the scoring data awarded by each said student to other students from the plurality of students and calculated performance values for each of said other students marked by each said student, and calculating an overall result for each said student from said calculated performance value and said conformance value.

For greater levels of accuracy, higher levels of redundancy can be introduced, i.e. each answer by each said student may be distributed to at least three or more other students from the plurality of students. As far as possible, each student only sees one answer from any other students although this depends on the ratio of students to questions. Answers are completely anonymous so students do not know whose answers they are reviewing.

At least two answers to a particular question may be allocated to each said student whereby said scoring data comprises a relative ranking of each of said at least two answers. All collected relative rankings may be compiled into an overall ranking with each student having a performance ranking in said overall ranking. Grade boundaries may be defined in said overall ranking and said performance value may be the grade awarded to each student, e.g. A, B, C or Pass, Merit, Distinction. Said assessment methodology is known as Thurstone Paired Ranking (see “Could Comparative Judgements of Script Quality Replace Traditionaf Marking and Improve the Validity of Exam Questions” by Pollitt et al presented at the British Educational Research Association Annual Conference, UMIST, Manchester September 2004).

Said conformance values for each student may also be ranked in a similar manner to said scoring data to determine a conformance ranking for each student. The result Rᵢ may be calculated as:

R₁=wPR₁+(1−w)CR₁

where w is the weighting applied to the mark awarded to the answer,
PRᵢ is the performance ranking of students, and
CRᵢ is the conformance ranking for the studentᵢ

Alternatively, a mark scheme may be distributed to each said student whereby said scoring data comprises a mark awarded by each said student based on said mark scheme. The performance value may thus be a performance mark. Outlying results in said data may be identified by identifying marks awarded by each said student for a particular answer by a particular student that vary more than a threshold level from marks awarded by other students for the same particular answer from the same particular student. The marks awarded by the students may follow a distribution pattern and boundaries defining the threshold level(s) may be set on the distribution pattern to define outlying results.

The overall result Rᵢ may be determined as a weighted sum of the performance value and the conformance value:

Rᵢ=wMᵢ+(1−w)Cᵢ

where w is the weighting applied to the mark awarded to the answer,
Mᵢ is the mark awarded to studentᵢ based on the marks awarded by fellow students and
Cᵢ is the conformance value for the studentᵢ

In both types of scoring scheme, the conformance value is an indicator of the conformance of an individual student to the consensus of the marks attached by each student. A higher value of w places less value on the conformance of the marking by the student. If the value of w is too close to 1, i.e. greater than 0.9, there is little incentive for a student to be consistent in their marking. Similarly, the value of w should not be too low, e.g. less than 0. 1, or there is little incentive for a student to perform well in the exam itself. The weighting applied is likely to be related to the amount of time that each task takes to perform. For example, if the test takes two hours and marking takes 30 mins, the weighting may be proportional to this difference in timing, i.e. w=0.8. The teacher (or assessor) setting the test may set the weighting.

By setting an appropriate weighting, there is an incentive for a student to mark accurately. This also reduces or even removes collusion and helps the students to learn the material thoroughly by having to carefully think through their marking. As an added incentive, the level of agreement of each student may also be published in a league table.

The method preferably comprises identifying outlying data in said scoring data. Identified outlying data in said scoring data are preferably disregarded before calculating a performance value for each said student. Each of said students awarding more than a threshold number of outlying results to said other students may be flagged as an outlying scorer. Each answer reviewed by each said outlying scorer may be redistributed to at least one other students from the plurality of students.

The invention further provides computer program code for controlling a computer or computerized apparatus to implement a method or system as described above. The code may be provided on a carrier such as a disk, for example a CD- or DVD-ROM, or in programmed memory for example as Firmware. Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog (Trade Mark) or VHDL (Very high speed integrated circuit Hardware Description Language). As the skilled person will appreciate such code and/or data may be distributed between a plurality of coupled components in communication with one another.

In a further aspect the invention provides a computer system or education network for determining the performance of a student in a test sat by a plurality of students, comprising
a database storing a test to be assessed for said plurality of students;
a plurality of student work stations connected to said database to enable said plurality of students to input answers to said task, wherein said answers are stored on said database; and a controller which is configured to
distribute each answer by each said student to at least two other students from the plurality of students;
collect scoring data for each answer from the at least two other students;
calculate a performance value for each said student based on said collected data;
calculate a conformance value for each said student based on the difference between the scoring data awarded by each said student to other students from the plurality of students and calculated performance values for each of said other students reviewed by each said student, and
calculate an overall result for each said student from said calculated performance value and said consistency value.

### BRIEF DESCRIPTION OF THE DRAWINGS

These and other aspects of the invention will now be further described, with reference of the accompanying figures in which:

FIG. 1 shows a schematic block diagram of a computer system for marking scripts prepared by students;

FIG. 2 is a flowchart setting out the steps for marking scripts where a teacher has defined a marking scheme;

FIG. 3 is a flowchart setting out the steps for marking scripts using a technique called “thurstone paired ranking”; and

FIG. 4 is a graph showing a variety of distributions with threshold lines defining outlying marks.

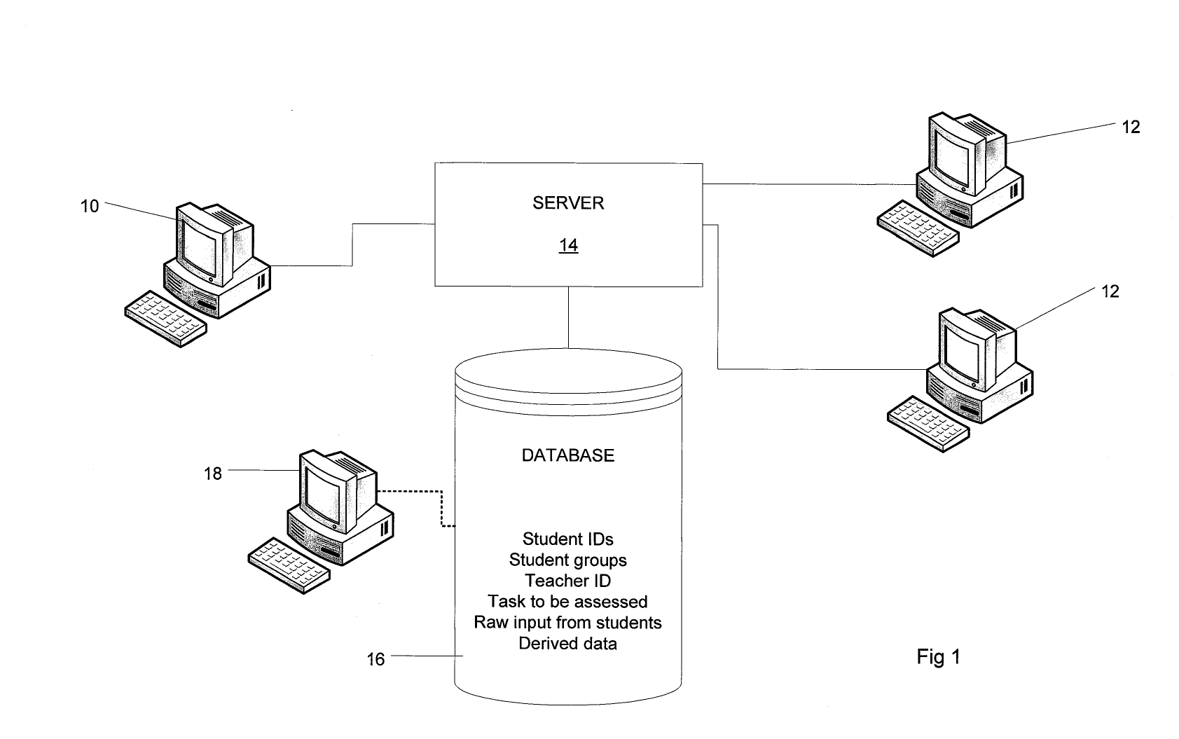

FIG. 1 shows a computer system or education network comprising a plurality of personal computers 10,12 connected by a server 14. There is at least one personal computer 10 for a teacher to set a test and a plurality of personal computers 12 for students sitting the test (for ease only two student computers are shown). The server 14 is also connected to a database 16 which stores identification information for both students and teachers. The test (or task to be assessed), e.g. questions, together with any markscheme, is also stored on the database 16. The database also stores the raw input, i.e. the answers prepared by the students and data derived from this raw input, i.e. marks or rankings for students. The students may be grouped into sets/groups and the information on such sets/groups is also stored on the database.

The computers 10,12 and database 16 may be connected to the server 14 through any standard means, e.g. a wired network or a wireless network such as the Internet.

An additional filtering computer 18 is also connected to the database 16. The filtering computer 18 extracts information from the database, for example, information on how a particular student or group of students have performed. Such filtered information may be provided to third parties, for example to prepare an educational package designed to improve the performance of the particular student or group of students.

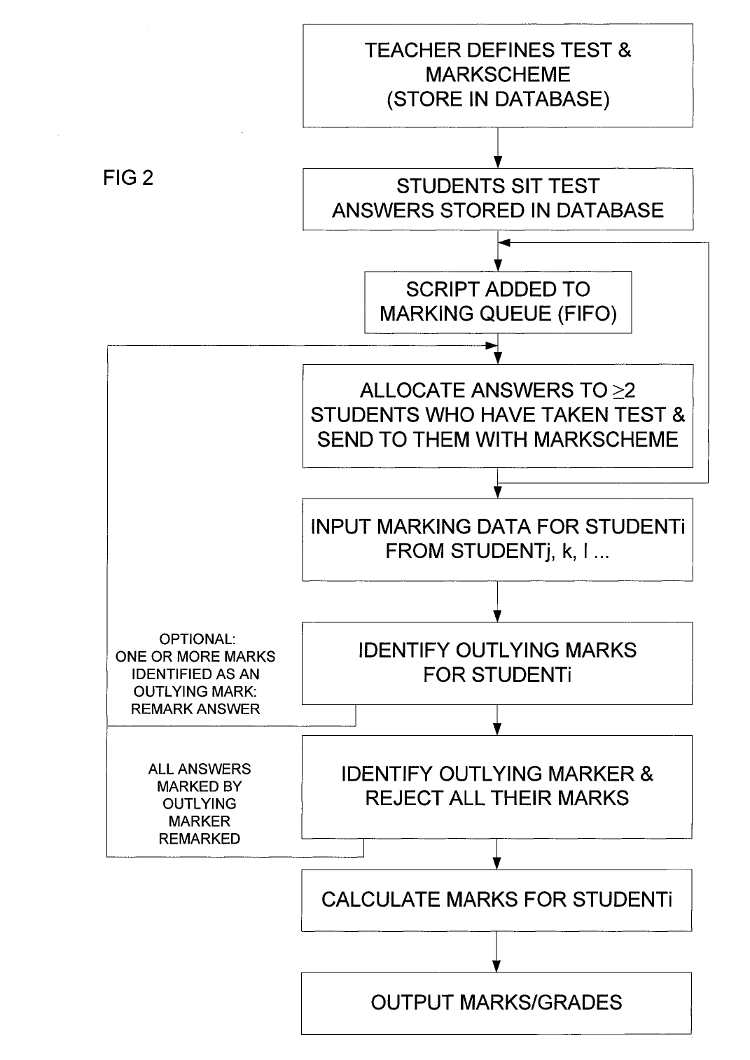

FIG. 2 shows how the computer based marking system depicted in FIG. 1 is implemented for a test having a defined mark scheme. A mark scheme defines correct answers and specifies the number of points to be given. As shown in FIG. 2 both the test and mark scheme are stored in the database. The test is then transmitted via the server to all students sitting the test. The students may sit the test online or may download the test for answering on their computer whilst the computer is offline. The answer script prepared by the student is stored in its own database record within the database. If a student is sitting the test online, the answer script may be transmitted instantaneously via the network to the database. If the student is working offline, the student must reconnect to the server to transmit the answer(s).

The answer scripts are then allocated for marking to the students who have sat the test. Whole scripts may be allocated to students or alternatively, the scripts may be divided into the answers to individual questions and the answers may be randomly distributed. Each answer is presented to at least two different students.

As shown in FIG. 2, answer allocation is achieved in a two-step process in which received scripts are added to a marking queue, which typically is a First In First Out queueing system. An answer from a script in the queue is then allocated to at least two students, preferably a minimum of three students and sent to these students with a markscheme. These steps are repeated until all the scripts from the students have been allocated. Each student then allocates a mark to the answer and provision may also be made for a student to add a comment.

The scoring data for each answer from all students that have marked the answer is then input to the server. In other words, scoring data for studentᵢ from studentⱼ, studentₖ, student₁ for all students 1 to n is inputted. The next step is to identify all the outlying marks for students. Pairs (or groups where more than two students mark each answer) of answers are compared by the system to identify outlying marks. For example the marks for studentᵢ for his answer to question 1 may be:

studentⱼ awards 7/10

studentₖ, awards 3/10

The variance between these awarded marks is significant. The system may define predetermined variance criteria outside which the answer is presented to a teacher or another student for a “best of three” analysis. If this student₁ awards 7/10, the mark of 3/10 awarded by studentₖ is an outlying mark. Since one mark has been identified as an outlying mark, the answer may then be optionally remarked.

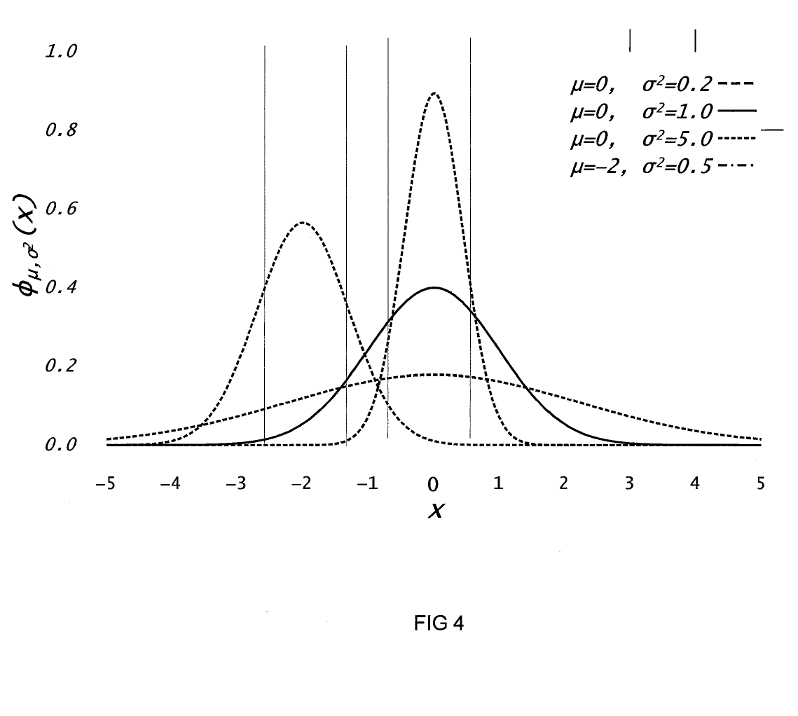

The marks awarded by the students may be expected to follow a distribution pattern and boundaries may be set on the distribution pattern to define outlying marks. For example, FIG. 4 shows four variations of the normal distribution and boundaries lines with marks falling outside the narrow strip being considered as outlying marks. Thus any marks which are greater than or less than the centre point of the distribution by more than the standard deviation may be classed as outlying marks. Checking for outlying marks is repeated for all answers in all scripts.

The fact that studentₖ has given an outlying mark is logged. If a student provides more than a threshold number of outlying marks, the student is identified as an outlying marker and all their marks are rejected. Each answer marked by an outlying marker is fed back into the system for remarking. Alternatively, each answer may only be fed back into the system for remarking if the count of the number of non-outlying markers falls below a threshold value, e.g. 2 or 3.

Once outlying markers and marks have been identified and all answers marked by a sufficient number of markers, the overall result for each students for each answer are calculated. The result Rᵢ may be calculated as:

Rᵢ=wMᵢ+(1−w)Cᵢ

where w is the weighting applied to the mark awarded to the answer,
Mᵢ is the mark awarded to studentᵢ based on the marks awarded by fellow students and
Cᵢ is the conformance value for the studentᵢ

Mᵢ may be calculated in many ways, for example, the mode of all non-outlying marks. Alternatively, Mᵢ may be an average of non-outlying marks, e.g.

$${M}_{i} = \frac{1}{p} {\sum }_{j = 1}^{p} {M}_{i , j}$$

where M_{i,j} is the mark provided by studentⱼ, and

p is the number of non-outlying students that marked the answer for studentᵢ

Thus for the example listed above,

$${M}_{i} = \frac{\frac{7}{10} + \frac{7}{10}}{2} = \frac{7}{10}$$

If an additional student marks the answer and awards a mark of 6/10.

$${M}_{i} = \frac{\frac{7}{10} + \frac{7}{10} + \frac{6}{10}}{3} = \frac{6.67}{10}$$

Cᵢ is a function of all differences between the actual mark Mⱼ awarded to each studentⱼ and the mark M_{j,i} awarded to each studentⱼ by students, i.e.

Cᵢ=f(Δᵢ, ∀j ε1 . . . m)

where

Δᵢ=|Mⱼ−M_{i,j}|

and m is the number of papers marked by studentᵢ.

The conformance value may be function of 1/Δ.

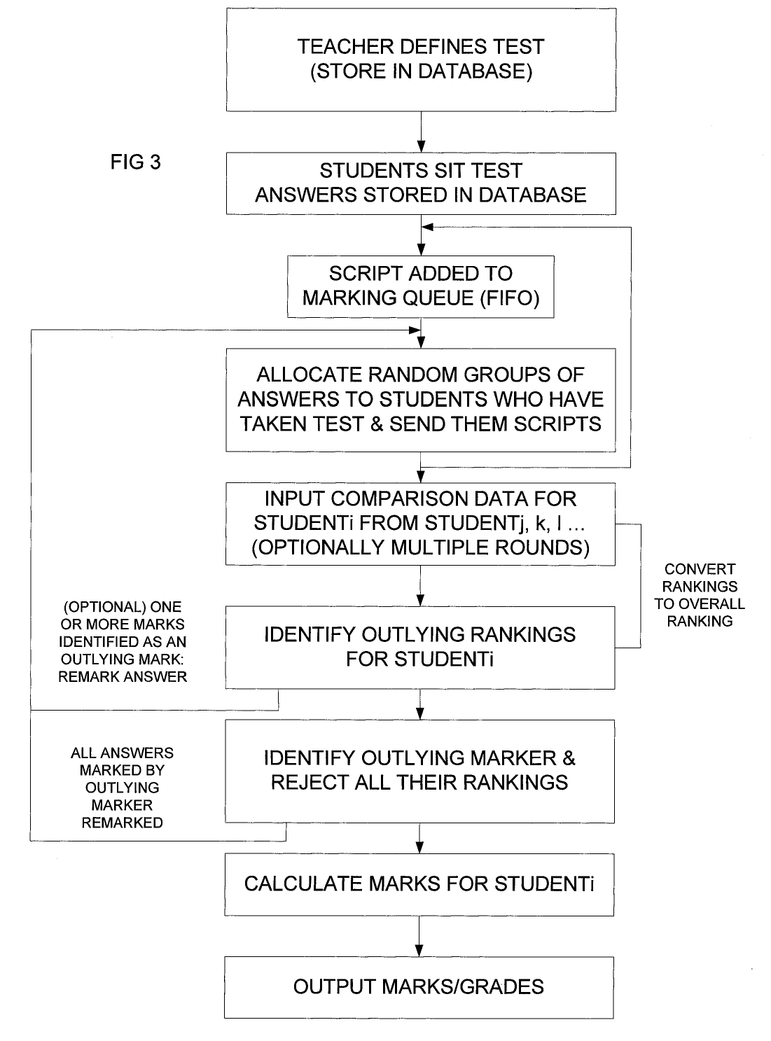

FIG. 3 shows how the scheme of FIG. 2 is adapted for a test using an assessment methodology known as Thurstone Paired Ranking (see “Could Comparative Judgements of Script Quality Replace Traditional Marking and Improve the Validity of Exam Questions” by Pollitt et al presented at the British Educational Research Association Annual Conference, UMIST, Manchester September 2004). This paper is herein incorporated by reference. Instead of using a mark scheme, multiple examiners compare items to be assessed (scripts/answers) in pairs and make a simple judgment of which one is better. These judgements are then aggregated into a rank order. If necessary the ranking can be converted to grades by designating grade boundaries. Grades are typically states as A, B, C or Pass, Merit, Distinction.

As shown in FIG. 3, many of the steps are similar to those in FIG. 2. Thus the first step is to define the test and store it in the database. The test is then transmitted via the server to all students sitting the test. The answer scripts are then allocated for review to the students who have sat the test.

Like FIG. 2, answer allocation is achieved in a two-step process in which received scripts are first added to a reviewing queue, which typically is a First In First Out queueing system. Thereafter the answer allocation differs from that in FIG. 2.

Groups of at least two answers are allocated to students such that each answer is compared multiple times, e.g. by defining multiple groups each containing at least one answer common to all groups or by sending the same group to multiple students.

The comparison or ranking data for each answer from all students that have reviewed the groups of answers is then input to the server. In other words, comparison data from studentⱼ, studentₖ, student₁ for all students 1 to n is inputted. The rankings are converted to an overall ranking. Optionally, the comparison step is repeated several times so that similarly ranked answers are compared to refine the overall ranking of the answers.

The next step is to identify all the outlying rankings for studentᵢ. This may be done by optionally defining grade boundaries, e.g. the top ten ranked students are grade A, the next twenty ranked students are grade B and the final ten students are grade C. Thus students may be ranked for his answer to question 1 as:

studentⱼ awards A

studentₖ, awards C

studentᵢ, awards A

Thus, the grade awarded by studentₖ is an outlying ranking. As in the previous example, the fact that studentₖ has given an outlying ranking is logged. If a student provides more than a threshold number of outlying rankings, the student is identified as an outlying scorer and all their rankings are rejected. Each answer marked by an outlying scorer may be fed back into the system for remarking. Alternatively, each answer may only be fed back into the system for remarking if the count of the number of non-outlying scorers falls below a threshold value, e.g. 2 or 3.

Once outlying scorers and rankings have been identified and all answers compared by a sufficient number of students, the overall result for each studentᵢ for each answer is calculated. The result Rᵢ may be calculated as:

Rᵢ=wPRᵢ+(1−w)CRᵢ

where w is the weighting applied to the mark awarded to the answer,

PRᵢ is the performance ranking of studentᵢ, and

CRᵢ is the conformance ranking for the studentᵢ

CRᵢ is an overall ranking of conformance values for each student with the conformance value Cᵢ being a function of the differences between the actual ranking Rⱼ awarded to each studentⱼ and the mark R_{j,i} awarded to studentⱼ by studentᵢ for all students marked by studentᵢ i.e.

Cᵢ=f(Δ₁, ∀j ε1 . . . m)

where

Δᵢ=|Rⱼ−R_{j,i}|

and m is the number of papers marked by studentᵢ.

In both the examples of FIGS. 2 and 3, the final result that a student is awarded thus depends on their level of agreement with other markers as well as their performance in the test itself. By setting an appropriate weighting, there is an incentive for a student to score accurately, e.g. according to the mark scheme for the scheme of FIG. 2.

The system is normally envisaged as being used with a single class, but it may also be used in a wider context. In this environment, no scripts may be allocated for marking until all students finish the test. The system may also be used for high-stakes testing. In this case, the system may be configured so no student reviews an answer originating from within his or her own school. In this case, it is possible that students in different time zones are sitting the test and thus not all students will finish the test at the same time. However, allocation of scripts need not be delayed until the final student has finished, for example, students from different schools sitting the test within a similar time frame or time zone may review each others answers.

No doubt many other effective alternatives will occur to the skilled person. It will be understood that the invention is not limited to the described embodiments and encompasses modifications apparent to those skilled in the art lying within the spirit and scope of the claims appended hereto.

1. A method of determining the performance of a student in a test sat by a plurality of students comprising
distributing each answer by each said student to at least two other students from the plurality of students;
collecting scoring data for each answer from the at least two other students;
calculating a performance value for each said student based on said collected data;
calculating a conformance value for each said student based on the difference between the scoring data awarded by each said student to other students from the plurality of students and calculated performance values for each of said other students marked by each said student, and
calculating an overall result for each said student from said calculated performance value and said conformance value.

2. A method according to claim 1, wherein the overall result is calculated as a weighted sum of said calculated performance value and said conformance value.

3. A method according to claim 1, comprising distributing at least two answers to a particular question to each said student whereby said scoring data comprises a relative ranking of each of said at least two answers.

4. A method according to claim 3, comprising compiling all collected relative rankings into an overall ranking and determining said performance value from said overall ranking.

5. A method according to claim 1, comprising distributing a mark scheme to each said student whereby said scoring data comprises a mark awarded by each said student based on said mark scheme.

6. A method according to claim 5, comprising identifying outlying marks by identifying marks awarded by each said student for a particular answer by a particular student that vary more than a threshold level from marks awarded by other students for the same particular answer from the same particular student.

7. A method according to claim 1, comprising identifying outlying data in said scoring data and disregarding said identified outlying data before calculating a performance value for each said student.

8. A method according to claim 7, comprising flagging as an outlying scorer each of said students awarding more than a threshold number of outlying data to said other students.

9. A method according to claim 8, comprising distributing each answer marked by each said outlying scorer to at least one other students from the plurality of students.

10. A carrier carrying computer program code to, when running, implementing the method of claim 1.

11. An education network for grading the performance of a student in a test sat by a plurality of students, comprising
a database storing a test to be assessed for said plurality of students;
a plurality of student work stations connected to said database to enable said plurality of students to input answers to said task, wherein said answers are stored on said database; and
a controller which is configured to
distribute each answer by each said student to at least two other students from the plurality of students;
collect scoring data for each answer from the at least two other students;
calculate a performance value for each said student based on said collected data;
calculate a conformance value for each said student based on the difference between the scoring data awarded by each said student to other students from the plurality of students and calculated performance values for each of said other students marked by each said student, and
calculate an overall result for each said student from said calculated performance value and said consistency value.

12. An educational tool according to claim 11 comprising at least one teacher work station connected to said database to set said task.
